(19) United States
(12) Patent Application Publication
(10) Pub. No.: US 2008/0157621 A1
(43) Pub. Date: Jul. 3, 2008

(54) ROTOR WINDING

(75) Inventor: Mark John DeBlock, Peterborough (CA)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/617,825

(22) Filed: Dec. 29, 2006

(51) Int. Cl. H02K 3/00

(52) U.S. Cl. 310/179

(57) ABSTRACT

Disclosed is a rotor winding including a winding strip configured to be disposed with a rotor, and at least one notch defined by a portion of the strip.

### FIELD OF THE INVENTION

The disclosure relates generally to a rotor winding, and more particularly to a rotor winding with an improved temperature transfer.

### BACKGROUND OF THE INVENTION

A copper winding is often disposed with a rotor to include copper turns of alternating widths. The narrow turn is referred to as the normal turn whereas the wide turns are referred to as the extended turns. The extended turns provide for a means for cooling the winding. When the airflow is parallel to an extended turn, the flow passes through the ventilation space created by adjacent extended turns, facilitating effective heat transfer. However, when the airflow is not parallel to the extended turn, the extended turn is less effective in heat transfer. In areas where the airflow pattern is perpendicular to the extended turn, the heat transfer is very ineffective.

As such, there is a desire in the field for a winding means that allows for more effective heat transfer in rotor areas where airflow is not parallel to extended turns of rotor winding.

### BRIEF DESCRIPTION OF THE INVENTION

Disclosed is a rotor winding including a winding strip configured to be disposed with a rotor, and at least one notch defined by a portion of the strip. Also disclosed is a rotor system including rotor windings, the system including a plurality of winding strips disposed with a rotor, and at least one notch defined by a portion of at least one of the strips.

Further disclosed is A method for improving heat transfer in a rotor system, the method including providing at least one notch in a portion of at least one of at least one winding strip, disposing the at least one winding strip with a rotor, aligning the at least one notch with an airflow running substantially perpendicular to the at least one winding strip, and transferring the perpendicular airflow throughout at least a portion of the system via a flowing of the airflow through the at least one notch.

### BRIEF DESCRIPTION OF THE DRAWINGS

The following descriptions should not be considered limiting in any way. With reference to the accompanying drawings, like elements are numbered alike:

FIG. 1 is a top view of a portion of a rotor winding in accordance with an exemplary embodiment;

FIG. 2 is an isometric perspective view of a portion of the portion of the rotor winding illustrated in FIG. 1;

FIG. 3 is a schematic end view of a rotor system including the rotor winding in accordance with an exemplary embodiment;

FIG. 4 is a schematic isometric perspective view of the rotor system illustrated in FIG. 3;

FIG. 5 is a schematic perspective view of the rotor system illustrated in FIG. 3, disposed with an electric machine;

FIG. 6 is a schematic front view of the rotor system illustrated in accordance with another embodiment; and

FIG. 7 is a block diagram illustrating a method for improving temperature transfer in a rotor system.

### DETAILED DESCRIPTION OF THE INVENTION

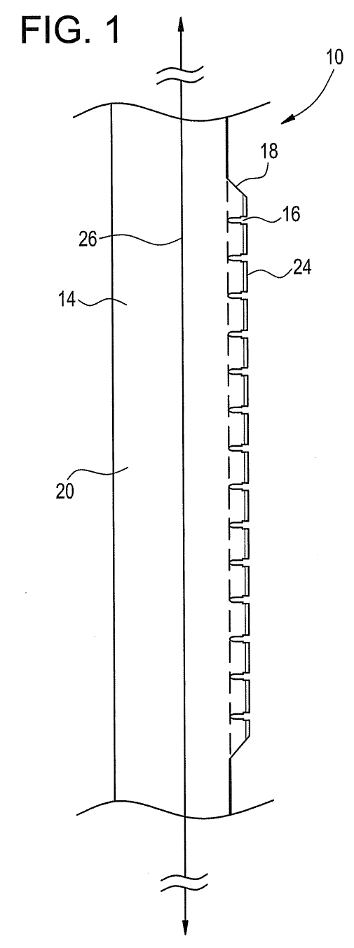

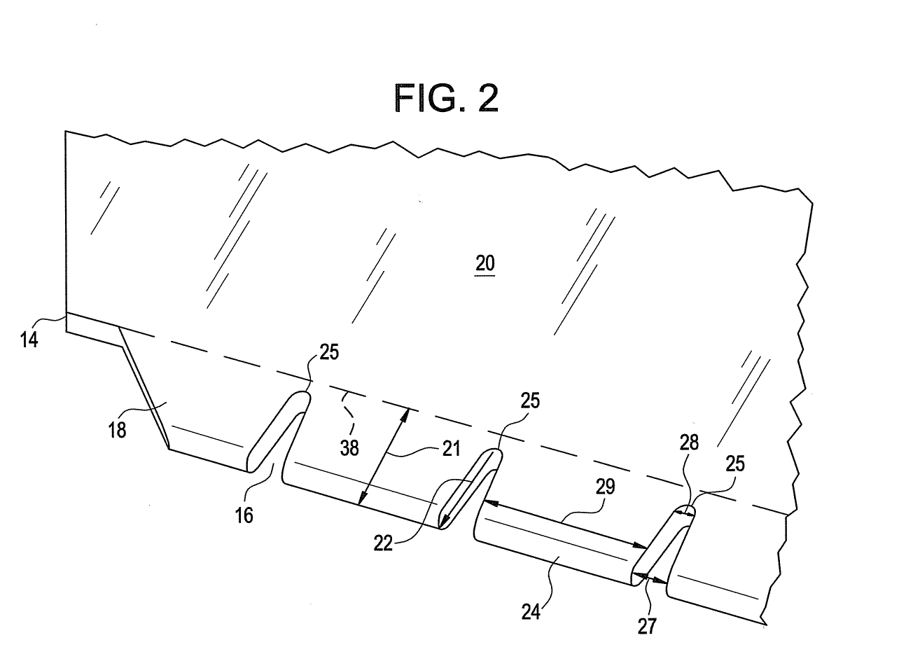

Referring to FIGS. 1-2, a rotor winding 10 configured for improving heat transfer is illustrated. The rotor winding 10 includes a winding strip 14, which defines at least one notch 16. As will be discussed later in the disclosure, the notches 16 defined by the strip 14 facilitate an improved heat transfer in a rotor system.

In an exemplary embodiment illustrated in FIGS. 1 and 2, the strip 14 is shown with an extended turn portion 18 and a non-extended turn portion 20. The extended portion 18 extends a fin depth 21 from the non-extended portion 20. As illustrated, the notches 16 are defined by the extended portion 18. Each notch 16 includes a notch depth 22 that extends from an outer edge 24 of the extended portion 18 of the strip 14 to an inner apex 25 of the notch 16, with the inner apex 25 being in proximity to the non-extended portion 20. In this embodiment, though the inner apex 25 of the notches 16 is in close proximity to the non-extended portion 20 of the strip 14, the inner apex 25 does not extend into the non-extended portion 20, and thus, the notch depth 22 is less than the fin depth 21. Configuring the notch depth 22 to be of a lesser extent than the fin depth 21 may minimize a possibility of a shorted turn when the winding 10 is in operation, and insure there is sufficient copper section for conduction.

Each notch 16 is also disposed at an angle substantially perpendicular to a longitudinal extent 26 of the strip 14, and may or may not be configured to be widest (see width 27 as compared with width 28) at the outer edge 24 of the strip 14, so as to facilitate air passage between the extended turns portions 18 (airflow will be discussed in greater detail later in the disclosure). Furthermore, the notches 16 are spaced from each other at a distance 29 selected to provide optimum heat transfer, for example a distance substantially equal to twice the extended turn depth 21. It should be appreciated that though the embodiment discussed above is the embodiment illustrated in the Figures, notches of any angle, geometry, notch depth, or spacing may be desirable to facilitate improved heat transfer of the winding 10. It should be additionally appreciated that strips that do or do not include extended turn portions 18 may also be desirable to facilitate improved heat transfer of the winding 10.

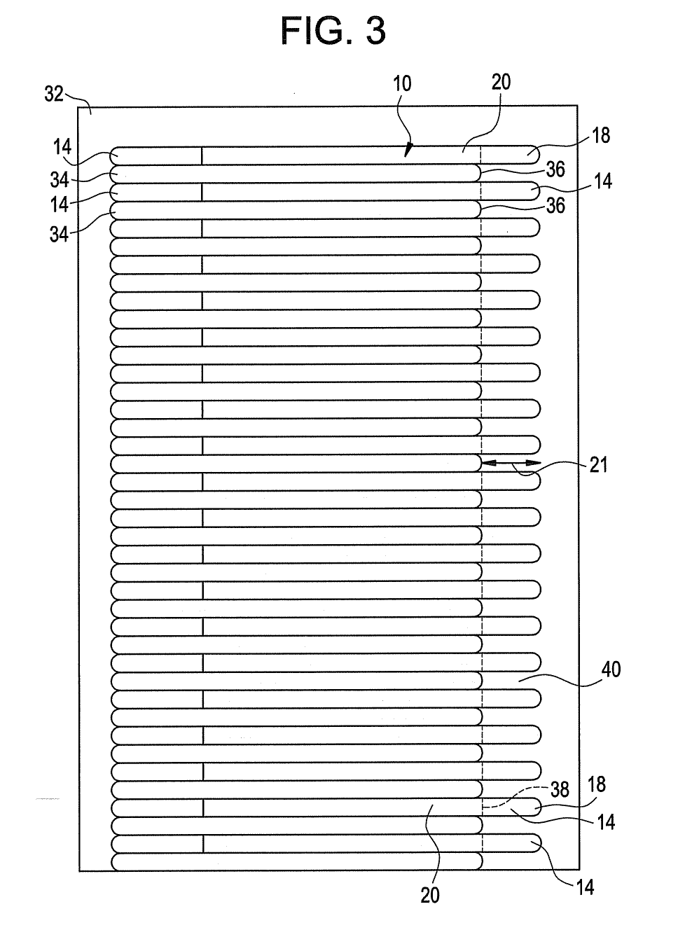

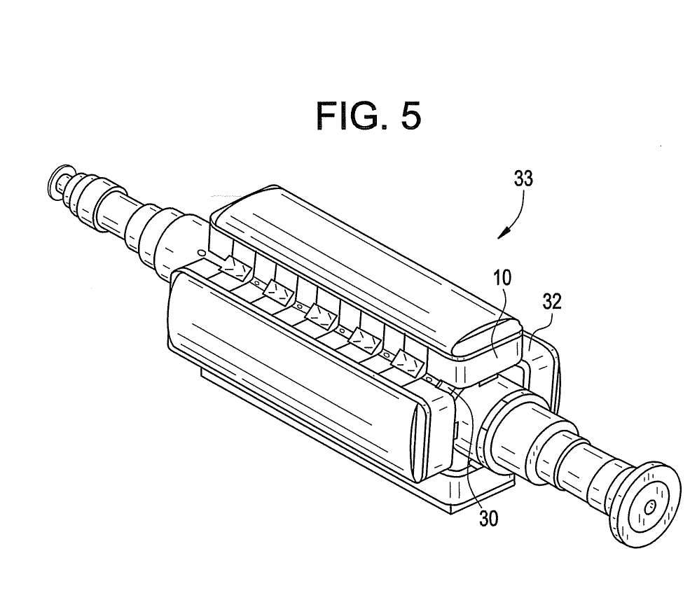

Referring now to FIGS. 3-5 in particular, the winding 10 may be disposed with a rotor 30 (such as the rotor of an electric machine) in a rotor system 32. As shown in the Figures, the rotor system 32 includes the rotor 30 and a plurality of winding strips 14 disposed with the rotor 30. In an exemplary embodiment, the winding strips 14 that include the notches 16 are extended turn strips that include the extended turn portions 18 discussed above. The extended turn strips illustrated in the system 32 include the exemplary characteristics of the winding strip 14 discussed above and illustrated in FIGS. 1 and 2. As such, when discussed with reference to the system 32, these extended turn strips will be referred to as extended turn strips 14.

As shown in FIGS. 3-5, the extended turn strips 14 are alternatingly disposed with non-extended turn strips 34. These non-extended turn strips 34 include an outer edge 36 (outer in relation to the rotor 30) that is substantially equal in distance from the rotor 30 with an outer extent 38 (outer in relation to the rotor 30) of the non extended portion 20 of the extended turn strips 14. As such, the extended portions 18 of the extended turn strips 14 extend beyond the non-extended strips 34 at a distance approximately equal to the fin depth 21. This alternating disposal of extended strips and non-extended strips 14 and 34 allows the extended portions 18 of the extended strips 14 to form ventilation spaces 40 in the rotor system 32 that run parallel to the extended and non-extended strips 14 and 34.

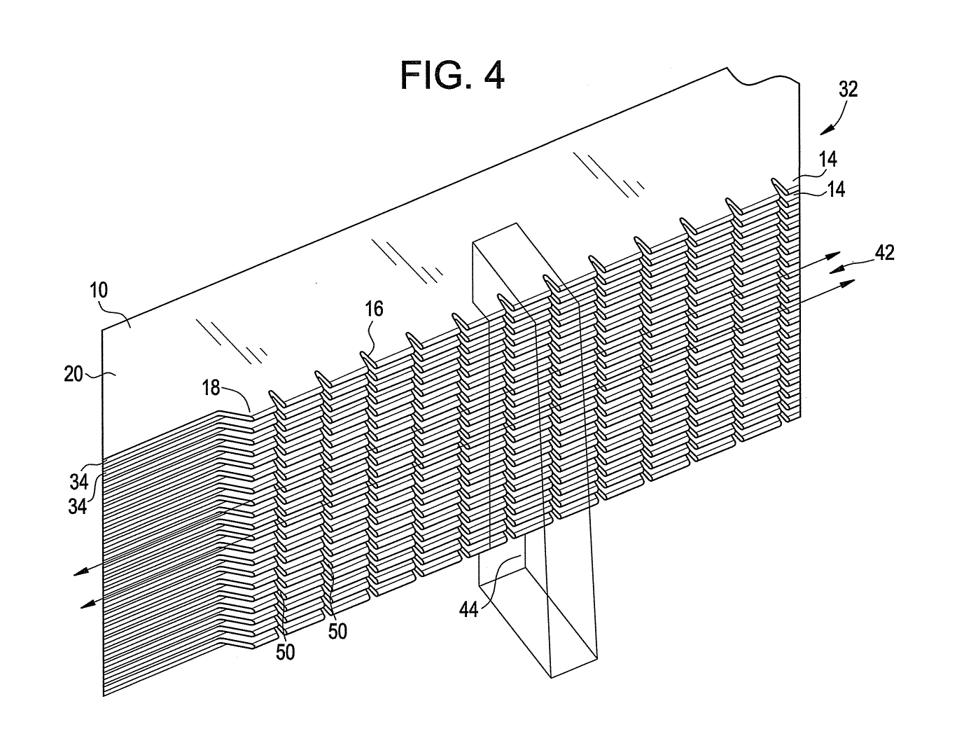

The parallel disposal of the ventilation spaces 40 allows a parallel running airflow 42 that travels parallel to the extended and non-extended strips 14 and 34 to be transferred throughout the system 32. As such, the ventilation spaces 40 effectively transfers heat throughout the operating rotor system 32. However, there may be airflow present in the system 32 (or in specific parts of the system 32) that does not flow parallel to the extended and non-extended strips 14 and 34. As shown in FIG. 4, this non-parallel airflow may be a perpendicular running airflow 44 that travels substantially perpendicular to the extended and non-extended strips 14 and 34. Being that the ventilation spaces 40 run perpendicularly to the perpendicular airflow 44, theses ventilation spaces 40 provide an ineffective means of transferring the perpendicular airflow 44 about the system 32.

In order to provide an efficient means for transferring non-parallel airflow, such as the perpendicular airflow 44, the notches 16 of each extended turn strip 14 are longitudinally aligned with the notches 16 of the rest of the extended turn strips 14, as shown in the exemplary embodiment of FIG. 4. This alignment creates air passages 50 that run perpendicularly to the extended and non-extended strips 14 and 34, providing a means of airflow transfer for the perpendicular airflow 44. As such, these perpendicularly disposed air passages 50 further provide an effective means of heat transfer in a direction perpendicular to the extended and non-extended strips 14 and 34, improving heat transfer within the system 32.

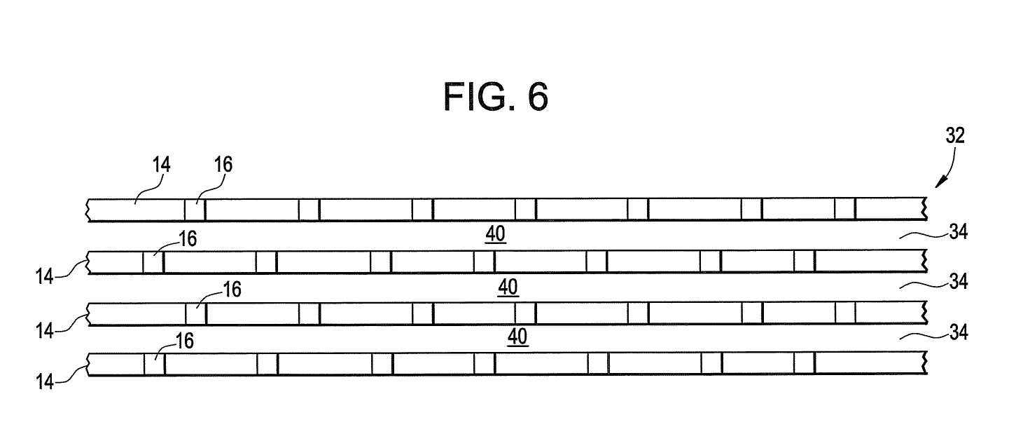

Referring to FIG. 6, it should also be appreciated that the notches 16 of adjacent strips 14 may also be staggered away from alignment. The staggered notches 16 of these strips 14 will not create the continuous air passages 50 described above and illustrated in FIGS. 3 and 4, but they will nonetheless facilitate transfer of non-parallel airflow such as the perpendicular airflow 44, improving heat transfer within the system 32.

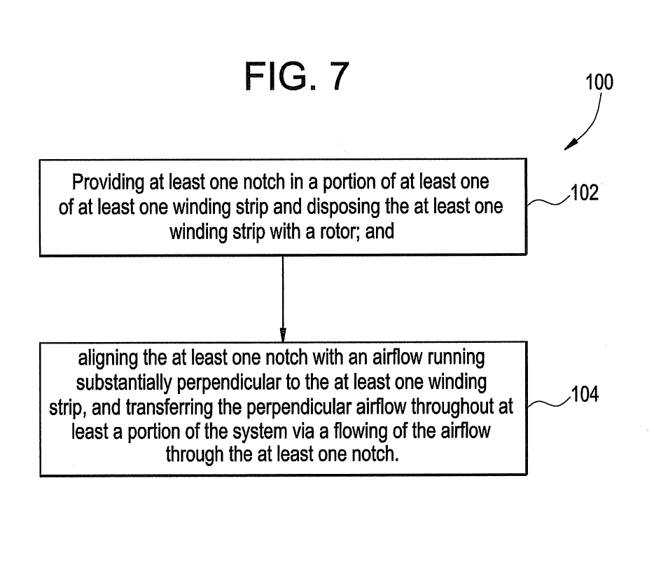

Referring now to FIG. 7, a method 100 for improving heat transfer in a rotor system 32 is illustrated and includes providing at least one notch 16 in a portion 18 of at least one of at least one winding strip 14 and 34 and disposing the at least one winding strip 14 with a rotor 30, as shown in operational block 102. The method 100 further includes aligning the at least one notch 16 with an airflow 44 running substantially perpendicular to the at least one winding strip, and transferring the perpendicular airflow 44 throughout at least a portion of the system 32 via a flowing of the airflow 44 through the at least one notch 16, as shown in operational block 104.

While the embodiments of the disclosed method and apparatus have been described with reference to exemplary embodiments, it will be understood by those skilled in the art that various changes may be made and equivalents may be substituted for elements thereof without departing from the scope of the embodiments of the disclosed method and apparatus. In addition, many modifications may be made to adapt a particular situation or material to the teachings of the embodiments of the disclosed method and apparatus without departing from the essential scope thereof. Therefore, it is intended that the embodiments of the disclosed method and apparatus not be limited to the particular embodiments disclosed as the best mode contemplated for carrying out the embodiments of the disclosed method and apparatus, but that the embodiments of the disclosed method and apparatus will include all embodiments falling within the scope of the appended claims.

What is claimed is:

1. A rotor winding comprising:
a winding strip configured to be disposed with a rotor; and
at least one notch defined by a portion of said strip.

2. The winding of claim 1, wherein said portion is an extended turn portion of said winding strip.

3. The winding of claim 1, wherein said at least one notch is disposed at an angle substantially perpendicular to a longitudinal extent of said winding strip.

4. The winding of claim 1, wherein said at least one notch includes a width that is widest at an outer edge of said winding strip.

5. The winding of claim 2, wherein said extended portion extends a fin depth from a non-extended portion of said winding strip, said at least one notch including a notch depth that is less than said fin depth.

6. The winding of claim 5, wherein said at least one notch is a plurality of notches, said plurality of notches being spaced at a distance configured to provide optimum heat transfer.

7. The winding of claim 1, wherein said strip includes a rectangular cross-section.

8. A rotor system including rotor windings, the system comprising:
a plurality of winding strips disposed with a rotor; and
at least one notch defined by a portion of at least one of said strips.

9. The system of claim 8, wherein said plurality of strips are disposed such that every other strip is an extended turn strip including an extend turn portion.

10. The system of claim 9, wherein said portion is said extended turn portion.

11. The system of claim 10, wherein said extended portion extends a fin depth from non-extended strips of said plurality of strips, said at least one notch including a notch depth that is less than said fin depth.

12. The system of claim 11, wherein said at least one notch is a plurality of notches in each of said extended turn strips, said plurality of notches being spaced at a distance approximately twice said fin depth.

13. The winding of claim 8, wherein said at least one notch is disposed at an angle substantially perpendicular to a longitudinal extent of said winding strip.

14. The system of claim 8, wherein said at least one notch includes a width that is widest at an outer edge of said plurality of winding strips.

15. The system of claim 8, wherein said winding strips are disposed such that said at least one notch of each of said plurality of strips is aligned with said at least one notch of any remaining strips of said plurality of strips that include said at least one notch.

16. The system of claim 8, wherein said winding strips are disposed such that said at least one notch of each of said plurality of strips is staggered from alignment with at least one of said at least one notch of any remaining strips of said plurality of strips that include said at least one notch.

17. A method for improving heat transfer in a rotor system, the method comprising:
providing at least one notch in a portion of at least one of at least one winding strip;
disposing said at least one winding strip with a rotor;
aligning said at least one notch with an airflow running substantially perpendicular to said at least one winding strip; and
transferring said perpendicular airflow throughout at least a portion of the system via a flowing of said airflow through said at least one notch.

18. The method of claim 17, wherein said at least one winding strip is a plurality of winding strips, the method further including alternating said plurality of winding strips between extended turn strips and non-extended strips, said extended turn strips each including said at least one notch.

19. The method of claim 18, wherein said portion is an extended turn portion of said extended turn strips.

20. The method of claim 19, further including aligning said at least one notch of each of the extended turn winding strips with said at least one notch of any remaining extended turn strips that include said at least one notch.
